(19) United States
(12) Patent Application Publication
(10) Pub. No.: US 2002/0138403 A1
(43) Pub. Date: Sep. 26, 2002

(54) Buyer managed order transmitting system and method

(76) Inventors: Robert A. Chesley, Newmarket, NH (US); Christopher J. Breault, Paxton, MA (US); John L. Doucette, Northbridge, MA (US); Michael P. Marvin, Chardon, OH (US); Joseph D. Sullivan JR., Cleveland, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/047,083

(22) Filed: Jan. 15, 2002

Related U.S. Application Data
(60) Provisional application No. 60/261,852, filed on Jan. 15, 2001.

(51) Int. Cl. G06F 17/60

(52) U.S. Cl. 705/37; 705/26

(57) ABSTRACT

A method for transmitting an order is provided. The method includes generating respective ordering data for a plurality of Buyers. The ordering data is represented as electronic signals and identifies the respective Buyer and an item. The ordering data is transmitted from the Buyers to a common computing device. One of a plurality of Vendors is identified as a function of the Buyer and the item. The order is generated for the Vendor. The order identifies the Buyer, the Vendor, and a quantity. The order is transmitted from the common computing device to the Vendor.

This application claims the benefit of U.S. Provisional Application No. 60/261,852, filed Jan. 15, 2001.

### BACKGROUND OF THE INVENTION

The present invention relates to remote ordering systems. It finds particular application in conjunction with a Buyer-managed remote ordering system using bar-code scanning technology within an internet-based environment and will be described with particular reference thereto. It will be appreciated, however, that the invention is also amenable to other like applications.

Remote order entry (ROE) systems have been proposed by suppliers of goods (Vendors) as a means of providing its customers (Buyers) (e.g., manufacturing plant facilities) with the ability to electronically order items from said Vendor. For example, some conventional ROE systems utilize bar-coding and electronic scanning technology to permit the Buyer to scan ordering data (e.g., item numbers and desired quantities) into a scanning device. The Buyer then transmits the ordering data from the scanning device directly to a single associated Vendor.

Another example is embodied in the “breadman” route delivery/shipping concept (the Breadman Concept). In the Breadman Concept, a representative (e.g., a sales representative) of a supplier (e.g., a Vendor) travels to several Buyers in a typical day. At each Buyer, the representative inspects the inventory levels of the respective items provided by the Vendor. If any of the inventory levels is below a predetermined level, the representative uses an electronic scanning device to scan a bar-code identifying the item and then manually enters an amount necessary to replenish the inventory level. At the end of the day (e.g., after visiting perhaps several Buyers), the representative uploads the orders entered into the scanning device to the Vendor. The representative may deliver the items to the Buyer during his next visit (e.g., the next business day).

ROE systems also have been proposed to Buyers by software vendors in the form of packaged or customized software applications, either on a stand-alone basis or part of a broader software system (On-Site ROE Systems). On-Site ROE Systems allow Buyers of goods to generate orders using a bar-code scanner and/or associated software to transmit orders to suppliers. Such systems require on-site computer hardware and software and associated installation, maintenance and integration to other systems as required.

Although such conventional ROE systems have partially automated the ordering process and offer advantages over manual processes (e.g. telephone, fax or paper-based orders) some drawbacks do exist. The conventional ROE system discussed above has failed to provide the user with a level of flexibility often desired from Buyers. More specifically, although conventional ROE systems have incorporated electronic scanning technology, each scanner is only associated with a single Vendor. Therefore, if a Buyer has a relationship with several Vendors and wishes to electronically order goods using a scanner, the number of scanners the Buyer must manage is directly related to the number of Vendors with which the Buyer has a relationship. Because Buyers typically work with at least several Vendors (and often times several dozen or even hundreds), the number of scanning devices a Buyer must maintain and use can be very large.

Since conventional ROE systems are typically provided to Buyers by its Vendors, and each Buyer is only associated with a single Vendor, different protocols and procedures are likely among the different ROE systems making for a complex, inconsistent, and inconvenient procedure for Buyers. For example, once a Buyer identifies the need to re-order an item, the Buyer must scan the item using the Vendor provided ROE system and then transmit the order to the associated supplier. Upon identifying another item from a different Vendor who has also provided a method for remote ordering, the Buyer again begins the process outlined above for the item and its associated Vendor. Because the items ordered using the scanning device may be high-volume items, the process of identifying items to be re-ordered may be performed many times in any given day. Therefore, managing the re-ordering process may involve transmitting ordering information to the respective Vendors using many different scanning devices and associated ROE systems every day.

In addition to the disadvantages discussed above, maintaining redundant ROE systems implies increased costs in the supply chain ultimately increasing product costs. Furthermore, On-Site ROE Systems and some conventional ROE systems require complex and often costly installation and maintenance of on-site software, computer hardware, and associated network infrastructure.

The present invention provides a new and improved apparatus and method which overcomes the above-referenced problems and others.

### SUMMARY OF THE INVENTION

In one embodiment, a method for transmitting an order is provided. The method includes generating respective ordering data for a plurality of Buyers. The ordering data is represented as electronic signals and identifies the respective Buyer and an item. The ordering data is transmitted from the Buyers to a common computing device. One of a plurality of Vendors is identified as a function of the Buyer and the item. The order is generated for the Vendor. The order identifies the Buyer, the Vendor, and a quantity. The order is transmitted to the Vendor.

In accordance with one aspect of the invention, transmitting the ordering data includes transmitting the ordering data for each of the Buyers to a network and transmitting the ordering data for each of the Buyers from the network to the common computing device.

In accordance with another aspect of the invention, transmitting the ordering data includes electronically transmitting the ordering data to the common computing device.

In accordance with another aspect of the invention, transmitting the order to the Vendor includes transmitting the order from the common computing device to a network and transmitting the order from the network to the respective Vendors.

In accordance with another aspect of the invention, transmitting the order to the Vendor includes at least one of manually transmitting the order to the Vendor and electronically transmitting the order to the Vendor.

In accordance with another aspect of the invention, the quantity is determined by the Buyer before the ordering data is transmitted to the common computing device.

In accordance with another aspect of the invention, the quantity is determined after the ordering data is transmitted to the common computing device.

In accordance with another aspect of the invention, the quantity is determined as a function of a default quantity or a replenishment quantity associated with the item as defined in the look-up tables on the common computing device.

In accordance with another aspect of the invention, the transmission of the ordering data for one of the Buyers to the common computing device is confirmed to the Buyer and/or the transmission of the order to the Vendor is confirmed.

In accordance with another aspect of the invention, the Vendor associated with the item is managed by the respective Buyer via a network connection to the common computing device.

One advantage of the present invention is that it permits a Buyer to use a single electronic input device for ordering items supplied by different Vendors.

Another advantage of the present invention is that it eliminates the need for a Buyer to purchase and maintain dedicated on-site software (e.g., at the Buyer's manufacturing facility).

Another advantage of the present invention is that it eliminates the need for integrating dedicated software into a Buyer's computer operating system.

Another advantage of the present invention is that is offers the Buyer flexibility in transmitting Orders to Vendors via electronic data interchange (EDI) and other electronic documents (e.g. XML protocols), facsimile, or a standard Internet browser depending on the Vendor's capability and preference.

Another advantage of the present invention is that it reduces costs associated with maintaining multiple electronic input devices.

Another advantage of the present invention is that it reduces costs associated with manually processing orders using traditional paper-based systems.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 illustrates an exemplary overall system diagram in accordance with a first embodiment of the present invention;

FIG. 2 illustrates an exemplary computer-implemented methodology in accordance with the present invention; and

FIG. 3 illustrates an exemplary illustration of ordering information in accordance with the present invention.

### DETAILED DESCRIPTION OF THE PREFERRED EMBODIMENTS

The following includes definitions of exemplary terms used throughout the disclosure. Both singular and plural forms of all terms fall within each meaning.

“Computer Readable Medium”, as used herein, includes but is not limited to any memory device, storage device, compact disc, floppy disk, or any other medium capable of being interpreted by a computer.

“Software”, as used herein, includes but is not limited to one or more computer executable instructions, routines, algorithms, modules or programs including separate applications or from dynamically linked libraries for performing functions and actions as described herein. Software may also be implemented in various forms such as a servlet, applet, stand-alone, plug-in or other type of application. Software can be maintained on various computer readable mediums as is known in the art.

“Signal”, as used herein, includes but is not limited to one or more signals, a bit stream, an algorithm, a routine, a program or the like. The term “command” is synonymous with “signal.”

“Network”, as used herein, includes but is not limited to the Internet, intranets, Wide Area Networks (WANs), Local Area Networks (LANs), Telecommunications Networks and transducer links such as those using Modulator-Demodulators (modems).

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

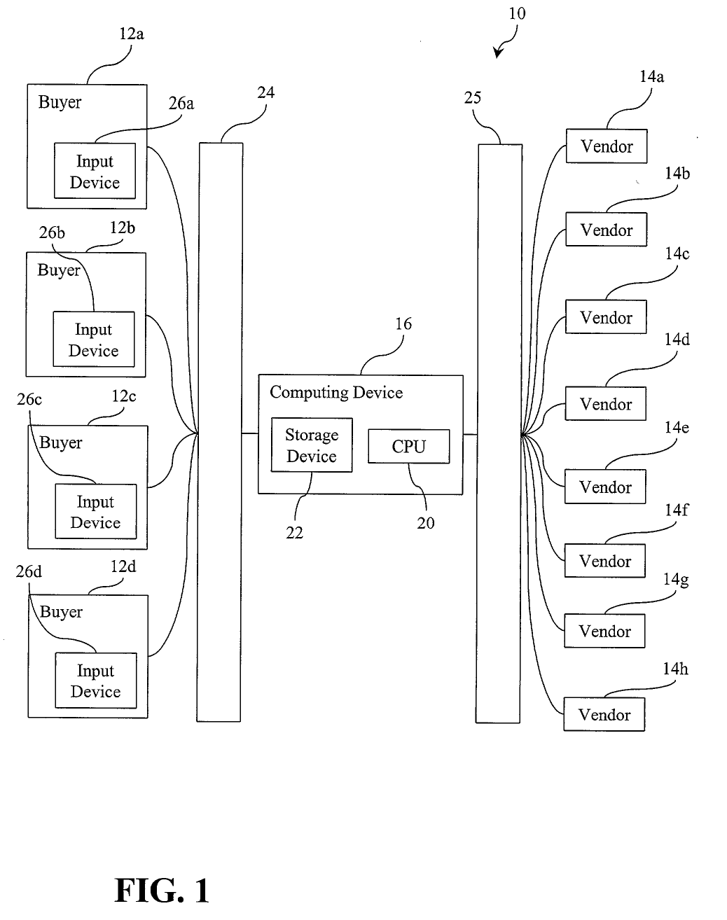

Illustrated in FIG. 1 is an exemplary schematic diagram of a system for transmitting orders for purchasing items in accordance with one embodiment of the present invention. A system 10 for purchasing items includes at least one Buyer 12. In the illustrated embodiment, four (4) Buyers 12a, 12b, 12c, 12d are shown. However, other numbers of Buyers are also contemplated. It is to be understood that the term Buyer as used within this disclosure is synonymous with both the term purchaser and the term customer. For purposes of illustration, it is assumed that each of the Buyers may be a facility (e.g., a manufacturing facility) that uses large numbers of purchased items. The inventory levels of such items typically need to be monitored and replenished on an as needed (e.g., daily or even hourly) basis.

The system 10 also includes at least one Vendor 14. In the illustrated embodiment, eight (8) Vendors 14a, 14b, 14c, 14d, 14e, 14f, 14g, 14h are shown. However, other numbers of Vendors are also contemplated. It is to be understood that the term Vendor as used within this disclosure is synonymous with both the term seller and the term supplier. For purposes of illustration, it is assumed that each of the Vendors is a facility that supplies large numbers of one or more of the items.

A computing device 16 includes a central processing device (CPU) 20 (e.g., a central controller) and a storage device 22. It is to be understood that the computing device 16 may represent a computer system, which executes software and processes information. The computer system 16 generally may take many forms, from a configuration including a variety of remotely hosted processing units, networked together to function as an integral entity, to a single computer (e.g., a personal computer, operational in a stand-alone environment). The present invention can be embodied in any of these computer system configurations but is illustrated in FIG. 1 as a single, common computing device 16, which, in one embodiment, acts as a remote host that is accessed by each of the Buyers 12. As known in the art, computer systems may include a variety of components and devices such as a processor, memory, data storage, data communications bus, and a network communications device.

As discussed in more detail below, the Buyers 12 and Vendors 14 communicate with the computing device 16 via communication networks 24, 25, respectively.

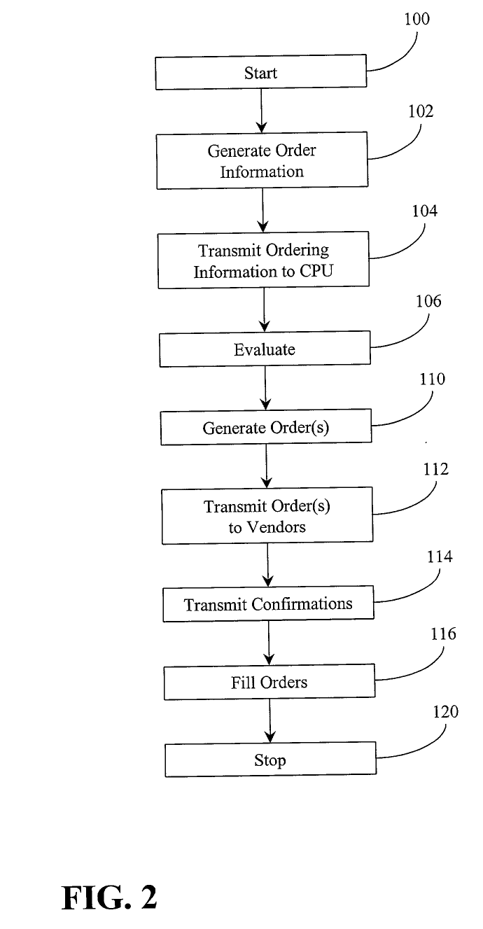

Illustrated in FIG. 2 is an exemplary computer-implemented methodology for transmitting an order for an item (article) from one of the Buyers 12 to one of the Vendors 14 in accordance with the present invention. The order is initiated by the Buyer 12 to obtain (e.g., purchase) items (articles) from the Vendors 14. More specifically, the Buyer 12 transmits ordering information (ordering data) to the computing device 16. The computing device 16 creates one or more orders as a function of the ordering information and transmits the order(s) to one of the Vendors 14. The blocks shown represent functions, actions, or events performed therein. It will be appreciated that computer software applications involve dynamic and flexible processes such that the illustrated blocks can be performed in sequences other than the one shown. It will also be appreciated by one of ordinary skill in the art that the software of the present invention may be implemented using various programming approaches such as procedural, object-oriented and/or artificial intelligence techniques.

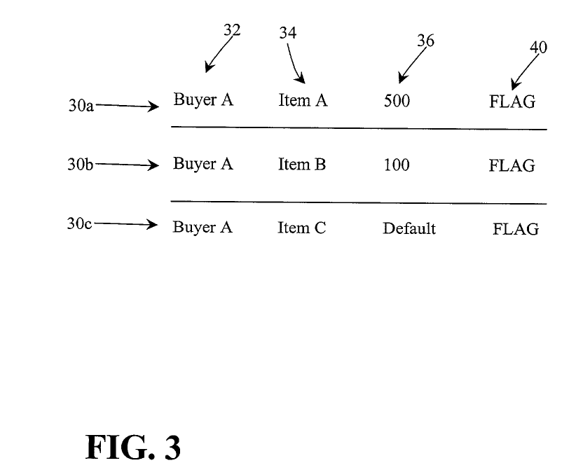

Illustrated in FIG. 3 is an exemplary illustration of the ordering information transmitted from the Buyer 12 to the computing device 16. The ordering information includes one (1) or more (e.g., three (3)) lines 30a, 30b, 30c. Each of the lines 30 identifies the Buyer 32, the desired item 34, and a quantity identifier 36. In one embodiment, the desired item 34 is an identifier including a Buyer's part number, which may be represented as alpha-numeric characters.

With reference to FIGS. 1-3, the method for a Buyer (e.g., the Buyer 12a) to transmit an order starts in a block 100. The ordering information, which is represented as one or more electronic signals, for the Buyer 12a is generated in a block 102.

In one embodiment, the ordering information is generated using input devices 26 (e.g., electronic optical scanning devices such as bar-code scanning devices) maintained by the respective Buyers 12. More specifically, each of the Buyers 12a, 12b, 12c, 12d maintains a respective bar-code scanning device 26a, 26b, 26c, 26d, which is used for scanning each of the items to be ordered for the Buyer's facility. In the current example, the device 26a is used by the Buyer 12a.

In another embodiment, the Buyers may maintain and use a plurality of scanning devices. In that case, each of the scanning devices is substantially capable of performing the same tasks. More specifically, each of the scanning devices is capable of obtaining ordering information for the same items. In this sense, multiple scanning devices at the Buyer's facility are interchangeable and, furthermore, are merely maintained for the Buyer's convenience (e.g., multiple scanning devices can be located and used at different areas of the Buyer's facility).

In one embodiment, each of the input devices 26 represents a “dumb” ordering terminal that merely gathers and stores the ordering information. As described in more detail below, the ordering information is uploaded (transmitted) from the input device 26 to the common computing device 16 at a later time. Consequently, the Buyers 12 are only required to maintain its respective input device 26 and, furthermore, not required to purchase and/or maintain on-site ordering software. In other words, the Buyers 12 are merely required to purchase the input device 26, which are pre-configured as ordering terminals and are not required to make large investments in expensive Buyer-managed purchasing software and/or maintain such software on-site (e.g., at their facilities).

When a scanning device operator (e.g., an individual at the Buyer's facility) determines an inventory level of an item is below a first predetermined level (an order level), the operator uses the respective scanning device 26 to input an identifier (e.g., scan a bar-code) associated with the item. Next, a quantity identifier is determined. Three (3) different methods are contemplated for determining the quantity identifier, which is used by the CPU 20 for determining an order quantity, which would bring the inventory level of the item to a level at or above a second predetermined level (a replenishment level).

In the first method, the operator manually determines the desired quantity and enters the desired quantity into the scanning device 26. In this case, the desired quantity represents both the quantity identifier and order quantity. The quantity identifier is entered into the scanning device 26 via, for example, a numeric keypad, which is either incorporated into or communicates with the scanning device 26, or by scanning a bar-code indicative of the quantity. The quantity identifier is then transmitted to the computing device 16 at a later time. A flag 40 in the line of the ordering information is set to indicate that the quantity identifier represents the order quantity.

In one embodiment, the CPU maintains history and reporting capabilities allowing the Buyer to manage the process (see discussion below) and make informed decisions about, for example, reorder quantities.

In the second method, instead of entering the order quantity, the operator manually determines a current inventory quantity of the item (i.e., a quantity of the item currently on-hand at the Buyer's facility). The operator then enters the current inventory level into the scanning device 26 as the quantity identifier. The quantity identifier is transmitted to the computing device 16 at a later time. The flag 40 in the line of the ordering information indicates that the quantity identifier merely represents a level of the item currently on-hand. In this method, the computing device 16 maintains a look-up table of respective replenishment levels for the items and determines the order quantity as a function of the current inventory quantity (e.g., the quantity identifier) and associated replenishment level. Alternatively, the lookup table is maintained in the scanning device 26, which calculates the order quantity in a similar manner; then, as in the first method, the order quantity is transmitted as the quantity identifier to the computing device 16 and the flag is set appropriately.

In the third method, a preset (default) quantity is ordered as a function of the item. More specifically, a look-up table is maintained in the computing device 16 identifying respective order quantities as a function of the items. The order quantities are previously determined and stored in the look-up table as a function of expected order quantities and replenishment levels. Therefore, in this method, the flag 40 is set to indicate a default quantity is to be ordered. In this case, the quantity identifier is not used or, alternatively, is set to “DEFAULT.” The quantity identifier is transmitted to the computing device 16 at a later time. If the computing device 16 receives a quantity identifier having a flag set to “DEFAULT,” the order quantity is set as the preset, default value, which is retrieved from the look-up table. Optionally, the look-up table is maintained in the scanning device 26 and the default order quantity is retrieved from the look-up table; then, as in the first method, the order quantity is transmitted as the quantity identifier to the computing device 16 and the flag is set appropriately.

The electronic signals representing the ordering information (i.e., the electronic signal representing all of the orders) are transmitted from the scanning device 26a to the CPU 20, via the communication network 24, in a block 104. The ordering information is transmitted from the scanning device 26 to the CPU 20 on a regular basis (e.g., once daily) or “on-demand” (e.g., whenever the operator initiates the data transfer). In one embodiment, the communication network 24 utilized in the block 104 includes at least one of telephone communication, internet protocol communication (e.g., the Internet), and wireless communication. However, other embodiments, in which the communication network 24 utilizes other means of communication, are also contemplated. The CPU 20 evaluates, in a block 106, the electronic signals representing the ordering information to identify the flag for determining the order quantity and a respective one of the Vendors 14 associated with each of the items.

The order quantity is determined according to the methods discussed above. Furthermore, a lookup table stored in the storage device 22 is accessed by the CPU 20 for identifying the Vendors 14 as a function of the Buyer 12 and the item identifier. The lookup table associates each of the items ordered by the respective Buyers with a Vendor. As an example, two of the Buyers 12a, 12c may order the same item. Furthermore, the item may be supplied by multiple Vendors (e.g., the Vendors 14d, 14g). The Buyer 12a may have negotiated favorable purchasing terms for the item with the Vendor 14g; similarly, the Buyer 12c may have negotiated favorable purchasing terms for the item with the Vendor 14d. Therefore, the Buyers 12a, 12c may choose to purchase the item from different Vendors (e.g., Vendors 14g, 14d, respectively). In this case, the lookup table associates the item, when purchased by the Buyer 12a, with the Vendor 14g; similarly, the lookup table associates the item, when purchased by the Buyer 12c, with the Vendor 14d. The lookup table also correlates the Buyer's part number with a corresponding Vendor's part identifier (e.g., a Vendor's part number, which may be an alpha-numeric identifier). For the reasons discussed above, the CPU and/or the lookup table act as a means for identifying, as a function of the Buyer, a respective one of a plurality of Vendors associated with each of the items.

It is to be understood that the lookup table is typically created before any of the blocks in the methodology are completed. In one embodiment, the CPU 20 permits a batch of item identifiers (e.g., part numbers) and/or default quantities to be remotely uploaded from, for example, the input device(s) 26 for an initial data load. Furthermore, as discussed below, the lookup table may be modified at any time (e.g., when a Buyer-Vendor relationship changes because, for example, a Buyer chooses to obtain a particular item from another Vendor, when a Buyer and/or Vendor change a part number, and/or when a Buyer adds/deletes an item to be purchased using the system 10).

In a block 110, the computing device 16 generates a separate, discrete order for each of the Vendors 14 for which the ordering information received in the block 104 included associated items. More specifically, each order is generated as a function of the ordering information and the associated order quantities. For example, an order for the Vendor 14a is generated from the Buyer 12a if that Buyer 12a requests at least one item the Buyer 12a has previously associated with the Vendor 14a. In one embodiment, the order identifies the Buyer, the Vendor, the item(s) (e.g., according to the Vendor's part number and/or purchase order number), and the quantity determined according to the methods discussed above. It is to be understood that the purchase order number may be hand entered by the Buyer at the computing device 16, generated automatically by the computing device 16, or generated by the CPU 20 as a release off a predetermine purchase order number managed by the Buyer.

In a block 112, each of the orders is transmitted from the CPU 20 to the respective Vendors 14 via the communication network 25. Various means contemplated for transmitting the order(s) from the CPU 20 to the Vendor(s) 14 include facsimile, e-mail, EDI, telephone transmissions (e.g., using modulator-demodulators), wireless transmissions, Internet protocols (e.g. XML transactions) and cable modulator-demodulators, etc.

Respective confirmations for one or more of the orders is/are optionally transmitted from the CPU 20 to the Buyer 12 (via the communication network 24) and from the Vendors 14 to the Buyers 12 in a block 114 (via the communication network 25). A confirmation transmitted from the CPU 20 to the Buyer 12 indicates the ordering information transmitted in the block 104 has been successfully received in the CPU 20. The confirmation(s) transmitted from the Vendor(s) 14 to the Buyer 12 confirm the order transmitted in the block 112 has been successfully received by the Vendor 14. The confirmations transmitted from the Vendor(s) 14 optionally indicate expected shipment and/or delivery dates. Although the confirmation from the CPU 20 to the Buyer 12 is described as being transmitted after the order(s) is/are transmitted from the CPU 20 to the Vendor(s) 14, it is to be understood these confirmations may be transmitted anytime after the ordering information is received in the block 104.

In the embodiment illustrated in FIG. 1, the confirmations are transmitted from the Vendors 14 to the Buyers 12 via the communication networks 24, 25. However, other embodiments, in which the confirmations are transmitted directly from the Vendors 14 to the Buyers 12 via, for example, facsimile, telephone lines (with modulator-demodulators), wireless transmissions, EDI, Internet protocols (e.g. XML transactions) and/or cable modulator-demodulators, are also contemplated.

The orders are filled in a block 116. In other words, the articles are identified, gathered, and packaged by the respective Vendors 14 before being transferred to the Buyer 12 (e.g., delivered by the Vendor or shipped via an independent shipping company).

The methodology for permitting the Buyers 12 to obtain items from the suppliers 14 stops in a block 120.

In an alternate embodiment, it is contemplated that instead of being “dumb,” the input device 26 is a “smart” device such as, for example, a personal digital assistant (PDA). A smart input device 26 may provide a richer user interface and allow more information to be displayed to the user. Also, the PDA may be used as a means for entering commands to retrieve and display information such as order history, Buyer lists, items lists and other pertinent information.

The smart input device may also offer the user a means for inquiring about the availability of an item from a supplier and/or managing the supplier associated with a particular item. Additionally, the smart input device may provide a more convenient means for entering data (e.g., at least one of order quantities and other commands) than offered by the scanning device alone. It is also contemplated that a smart input device may include a means for transmitting order receipt information (e.g., via wireless means such as infra-red and/or radio frequency transmitters, cellular communications, wireless internet communications) to a capable output device. Furthermore, orders may be transmitted to the computing device 16 utilizing built-in synchronization methods (e.g., asynchronous dial-up, network internet protocol (IP) connection, and direct serial connection via, for example, wireless IP connections). The synchronization means may also be used for updating data collection applications (e.g., incorporating enhancements and/or “bug” fixes) in the scanning device during a synchronization, without requiring user intervention.

It is contemplated that the smart input devices may be used in the embodiments described above in which look-up tables are incorporated into the input device 26. Furthermore, whether the look-up tables are maintained on the input device 26 or on the computing device 16, it is contemplated that smart input devices may provide a means to the Buyer's for managing the look-up tables. For example, a Buyer may manage the look-up tables by updating default order quantities and/or replenishment quantities. Furthermore, a Buyer may change the Vendor associated with a particular item. Optionally, the Buyers may build and maintain a master database including allowable part identifiers that may be ordered using the device. Restricting an operator of the device to only being capable of ordering allowable parts provides the Buyer with a certain level of control over the ordering process.

If the look-up tables are maintained within the computing device 16, it is also contemplated that the Buyers 12 be capable of managing the look-up tables via any other terminal, which includes browser software, communicating with the computing device 16 via the communication network 24 (e.g., the Internet).

As discussed above, different means of communication are contemplated for the communication networks 24, 25 in different embodiments. For example, communications between the Buyers 12 and the computing device 16 are contemplated to be conducted electronically via, for example, at least one of telephone communications (e.g., modem), internet protocol communications, electronic data interchange, wireless communications, and e-mail communications. Communications between the Vendors 14 and the computing device 16 are contemplated to be conducted electronically and/or manually. Electronic communications between the Vendors 14 and the computing device 16 are contemplated to include the means listed above. Manual communications between the computing device 16 and the Vendors 14 are contemplated to include, for example, at least one of facsimile communications and standard mail. Additionally, communications directly between the Vendors 14 and the Buyers 12 (e.g., order confirmations transmitted from the Vendors to the Buyers that are not transmitted via one or both of the communication networks 24, 25) are contemplated to be conducted manually.

Although the present invention has been described with reference to an example involving a single Buyer 12a transmitting ordering information to the computing device 16, it is to be understood that the computing device 16 is also capable of receiving ordering information from any of the other Buyers 12b, 12c, 12d. Furthermore, the computing device 16 generates and transmits orders to any of the Vendors 14 (as a function of the ordering information) according to the same process discussed above.

While the present invention has been illustrated by the description of embodiments thereof, and while the embodiments have been described in considerable detail, it is not intended to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

Having thus described the preferred embodiment, the invention is now claimed to be:

1. A method for transmitting an order, the method comprising:
generating respective ordering data for a plurality of Buyers, the ordering data being represented as electronic signals and identifying the respective Buyer and an item;
transmitting the ordering data from the Buyers to a common computing device;
identifying one of a plurality of Vendors as a function of the item and the Buyer;
generating the order for the Vendor, the order identifying the respective Buyer, the Vendor, and a quantity; and
transmitting the order to the Vendor.

2. The method of transmitting an order as set forth in claim 1, wherein transmitting the ordering data includes:
transmitting the ordering data for each of the Buyers to a network; and
transmitting the ordering data for each of the Buyers from the network to the common computing device.

3. The method of transmitting an order as set forth in claim 1, wherein transmitting the ordering data includes:
electronically transmitting the ordering data to the common computing device.

4. The method of transmitting an order as set forth in claim 1, wherein transmitting the order to the Vendor includes:
transmitting the order from the common computing device to a network; and
transmitting the order from the network to the respective Vendors.

5. The method of transmitting an order as set forth in claim 1, wherein transmitting the order to the Vendor includes at least one of:
manually transmitting the order to the Vendor; and
electronically transmitting the order to the Vendor.

6. The method of transmitting an order as set forth in claim 1, further including:
determining the quantity before the ordering data is transmitted to the common computing device.

7. The method of transmitting an order as set forth in claim 1, further including:
determining the quantity after the ordering data is transmitted to the common computing device.

8. The method of transmitting an order as set forth in claim 1, further including one of:
determining the quantity as a function of a default quantity associated with the item; and
determining the quantity as a function of a replenishment quantity associated with the item.

9. The method of transmitting an order as set forth in claim 1, further including at least one of:
confirming the ordering data for one of the Buyers was transmitted to the common computing device; and
confirming the order was transmitted to the Vendor.

10. The method of transmitting an order as set forth in claim 1, further including:
managing, via the respective Buyer, the Vendor associated with the item.

11. A system for transmitting an order, comprising:
a plurality of electronic devices generating ordering data for respective Buyers, the ordering data being represented as electronic signals and identifying the respective Buyer and a respective item;
means for transmitting the ordering data from the Buyers to a common computing device;
means for identifying one of a plurality of Vendors as a function of the Buyer and the item;
means for generating the order for one the Vendor, the order identifying the respective Buyer, the Vendor, and a quantity; and
means for transmitting the order to the Vendor.

12. The system for transmitting an order as set forth in claim 11, wherein the means for transmitting the ordering data includes:
a network for electronically transmitting the ordering data to the common computing device.

13. The system for transmitting an order as set forth in claim 11, wherein the means for transmitting the order includes at least one of:
means for manually transmitting the order to the Vendor; and
a network for electronically transmitting the order to the Vendor.

14. The system for transmitting an order as set forth in claim 11, further including at least one of:
means for determining the quantity before the ordering data is transmitted to the common computing device; and
means for determining the quantity after the ordering data is transmitted to the common computing device.

15. The system for transmitting an order as set forth in claim 14, wherein:
the means for determining the quantity before the ordering data is transmitted to the common computing device includes:
a look-up table accessed by one of the electronic devices; and
the means for determining the quantity after the ordering data is transmitted to the common computing device includes:
a look-up table accessed by the common computing device.

16. The system for transmitting an order as set forth in claim 11, wherein the quantity is determined as a function of at least one of a default quantity associated with the item and a replenishment quantity associated with the item.

17. The system for transmitting an order as set forth in claim 11, further including at least one of:
means for transmitting a first confirmation from the common computing device to the respective Buyer as a function of successfully receiving the ordering data into the computing device; and
means for transmitting a second confirmation from the Vendor to the Buyer as a function of successfully receiving the order by the Vendor.

18. The system for transmitting an order as set forth in claim 11, further including:
means for changing the Vendor determined as a function of the item and the Buyer.

19. A method for obtaining articles from respective suppliers, the method comprising:
identifying, for each of a plurality of Buyers, a respective article via a respective electronic optical input device;
generating respective electronic ordering data as a function of the identified articles and the respective Buyer;
transmitting the electronic ordering data from the Buyers to a central processing device;
for each of the identified articles, identifying one of a plurality of Vendors as a function of the article and the Buyer;
for each of the identified articles, determining a respective quantity as a function of the article and at least one of a default quantity associated with the article, a replenishment quantity associated with the article, and a desired quantity identified by the Buyer;
for each of the identified Vendors, creating a respective order identifying each of the associated articles, the Buyer, and the respective quantities;
transmitting each of the orders to the respective Vendor; and
filling the orders.

20. The method for obtaining articles as set forth in claim 19, further including:
for one of the articles, changing, via the Buyer, the Vendor identified as a function of the Buyer.
